(19) United States
(12) Patent Application Publication
(10) Pub. No.: US 2022/0266267 A1
(43) Pub. Date: Aug. 25, 2022

(54) LIQUID JET NOZZLE AND LIQUID JET DEVICE

(71) Applicant: SEIKO EPSON CORPORATION, Tokyo (JP)

(72) Inventors: Hirokazu SEKINO, Chino-shi (JP); Yasunori ONISHI, Shiojiri-shi (JP); Takeshi SETO, Chofu-shi (JP)

(21) Appl. No.: 17/652,174

(22) Filed: Feb. 23, 2022

(30) Foreign Application Priority Data
Feb. 24, 2021 (JP) 2021-027342

(51) Int. Cl. B05B 1/08; B05B 1/10

(52) U.S. Cl. CPC B05B 1/08; B05B 1/10

(57) ABSTRACT

A liquid jet nozzle is a liquid jet nozzle that has a nozzle hole, and a liquid flow path having a diameter greater than that of the nozzle hole and coupled to the nozzle hole, and hits a droplet, generated from a continuous flow jetted from the nozzle hole, against a target object, wherein the nozzle hole has a cylindrical shape, and a curvature radius of an inlet edge of the nozzle hole is equal to or less than 25% of a nozzle hole diameter of the nozzle hole, the inlet being coupled to the liquid flow path.

The present application is based on, and claims priority from JP Application Serial Number 2021-027342, filed Feb. 24, 2021, the disclosure of which is hereby incorporated by reference herein in its entirety.

### BACKGROUND

### 1. Technical Field

The present disclosure relates to a liquid jet nozzle and a liquid jet device that jet liquid at a high pressure toward a target object to perform predetermined processing.

### 2. Related Art

In the past, an ultrasonic water jet device has been known in which a piezoelectric element is used to dropletize a continuous flow of high-pressure water, and collides a droplet with a target object to perform processing such as cutting or washing the target object (JP 2007-523751 T).

In addition, foam nozzle structure has been known that can discharge a spray liquid by forming foam in a continuous flow (JP 4-500038 T). In this foam nozzle structure, a rear edge formed roundly of each rib is formed in a circular shape with a radius R as a whole. Here, it is disclosed that, when a width of a slot with the radius R is S, a ratio R:S is from 1:2 to 1:4.

However, in any of the above documents, there is no description for considering that, when a droplet made by splitting up a continuous flow of liquid jetted from a jet port of a nozzle hole is caused to fly with good straightness, an impact pressure of the droplet is increased by jetting the liquid as a contraction flow.

In addition, in the foaming nozzle structure of JP 4-500038 T, the spray is deflected in various directions, so it is possible to reliably jet the droplet in an atomized state, but it is not possible to jet the droplet straightly, and difficult to increase the impact pressure of the droplet.

### SUMMARY

In order to solve the problem described above, a liquid jet nozzle according to the present disclosure is a liquid jet nozzle that has a nozzle hole, and a liquid flow path having a diameter greater than that of the nozzle hole and coupled to the nozzle hole, and hits a droplet, generated from a continuous flow jetted from the nozzle hole, against a target object, wherein the nozzle hole has a cylindrical shape, and a curvature radius of an inlet edge of the nozzle hole is equal to or less than 25% of a nozzle hole diameter of the nozzle hole, the inlet being coupled to the liquid flow path.

In addition, a liquid jet device according to the present disclosure is a liquid jet device including a liquid jet nozzle for hitting a droplet, generated from a jetted continuous flow, against a target object, the liquid jet device including a pressurized liquid supply unit configured to pressurize liquid and supply the liquid to the liquid jet nozzle, wherein the liquid jet nozzle has a nozzle hole, and a liquid flow path having a diameter greater than that of the nozzle hole and coupled to the nozzle hole, the nozzle hole has a cylindrical shape, and a curvature radius of an inlet edge of the nozzle hole is equal to or less than 25% of a nozzle hole diameter of the nozzle hole, the inlet being coupled to the liquid flow path.

### BRIEF DESCRIPTION OF THE DRAWINGS

FIG. 1 is an overall schematic configuration diagram of a liquid jet device including a liquid jet nozzle of Exemplary Embodiment 1 according to the present disclosure.

FIG. 2 is an enlarged cross-sectional view of a main part of the liquid jet nozzle of the above Exemplary Embodiment 1.

FIG. 3 is a graph showing a relationship between analysis value/theoretical value of a jetting velocity (vertical axis) and radius of curvature R of an edge of a nozzle hole (horizontal axis) when a nozzle hole diameter of the above Exemplary Embodiment 1 is 0.12 mm.

FIG. 4 is a graph showing a relationship between analysis value/theoretical value of a jetting velocity (vertical axis) and the radius of curvature R of an edge of a nozzle hole (horizontal axis) when the nozzle hole diameter of Exemplary Embodiment 1 is 0.08 mm.

FIG. 5 is a graph showing a relationship between analysis value/theoretical value of a jetting velocity (vertical axis) and the radius of curvature R of an edge of a nozzle hole (horizontal axis) when the nozzle hole diameter of Exemplary Embodiment 1 is 0.05 mm.

FIG. 6 is a graph showing a relationship between analysis value of a jetting velocity (vertical axis) and the radius of curvature R of an edge of a nozzle hole (horizontal axis) when a nozzle hole diameter of Exemplary Embodiment 2 is 0.12 mm.

FIG. 7 is a graph showing a relationship between analysis value of a jetting velocity (vertical axis) and the radius of curvature R of an edge of a nozzle hole (horizontal axis) when the nozzle hole diameter of Exemplary Embodiment 2 is 0.08 mm.

FIG. 8 is a graph showing a relationship between analysis value of a jetting velocity (vertical axis) and the radius of curvature R of an edge of a nozzle hole (horizontal axis) when the nozzle hole diameter of Exemplary Embodiment 2 is 0.05 mm.

FIG. 9 is a graph showing a relationship between analysis value/actual measured value of a jetting velocity (vertical axis) and the radius of curvature R of an edge of a nozzle hole (horizontal axis) when the nozzle hole diameter of Exemplary Embodiment 2 is 0.12 mm.

FIG. 10 is a graph showing a relationship between analysis value/actual measured value of a jetting velocity (vertical axis) and the radius of curvature R of an edge of a nozzle hole (horizontal axis) when the nozzle hole diameter of Exemplary Embodiment 2 is 0.08 mm.

FIG. 11 is a graph showing a relationship between analysis value/actual measured value of a jetting velocity (vertical axis) and the radius of curvature R of an edge of a nozzle hole (horizontal axis) when the nozzle hole diameter of Exemplary Embodiment 2 is 0.05 mm.

FIG. 12 is a high-speed photographic image obtained by photographing fly trajectories of droplets jetted from a nozzle hole and flying, using a high-speed camera.

### DESCRIPTION OF EXEMPLARY EMBODIMENTS

Hereinafter, the present disclosure will be schematically described first.

In order to solve the problem described above, a liquid jet nozzle according to a first aspect of the present disclosure is a liquid jet nozzle that has a nozzle hole, and a liquid flow path having a diameter greater than that of the nozzle hole and coupled to the nozzle hole, and hits a droplet, generated from a continuous flow jetted from the nozzle hole, against a target object, wherein the nozzle hole has a cylindrical shape, and a curvature radius of an inlet edge of the nozzle hole is equal to or less than 25% of a nozzle hole diameter of the nozzle hole, the inlet being coupled to the liquid flow path.

According to the present aspect, the curvature radius of an inlet edge of nozzle hole is equal to or less than 25% of the nozzle hole diameter of the nozzle hole, the inlet being coupled to the liquid flow path. As a result, the droplet made by splitting up the continuous flow of the liquid jetted from the jet port of the nozzle hole can be caused to fly with good straightness, and the liquid can be jetted as a contraction flow. By making the contraction flow, a jetting velocity is increased compared to a case where the contraction flow is not made, and therefore an impact pressure of the droplet can be increased by the increased jetting velocity.

In addition, as ease of forming the contraction flow, it is said that it is good to set the curvature radius of the edge of the nozzle hole to zero, that is, truly 90 degrees. However, it is difficult to create a nozzle hole having the radius of curvature of zero at the edge, and an attempt will be made to aim to create one such that a radius of curvature is close to zero as much as possible.

Under such circumstances, the inventors have confirmed that there was a range in which a contraction flow could be formed even when the curvature radius of the edge was not zero. That is, the inventors have confirmed that even when the curvature radius of the edge was not zero, the contraction flow could be formed to a certain range. Furthermore, the inventors have discovered, at the time of confirmation, that as the nozzle hole diameter is increased, the range in which the contraction flow could be formed widens. In the present aspect, “the curvature radius of the inlet edge is equal to or less than 25% of the nozzle hole diameter of the nozzle hole” is based on the discovery.

As a result, according to the present aspect, when a nozzle hole capable of forming the contraction flow is manufactured, it is not necessary to be vaguely conscious of aiming to make the curvature radius of the edge zero, that is, magnitude of a radius of curvature that is actually required can be grasped depending on the nozzle hole diameter of the nozzle hole, which makes the manufacturing easier.

A liquid jet nozzle according to a second aspect of the present disclosure is the liquid jet nozzle according to the first aspect, wherein the curvature radius of the edge is in a range from 5% to 10% of the nozzle hole diameter.

According to the present aspect, the curvature radius of the edge is in the range from 5% to 10% of the nozzle hole diameter. In a case of equal to or greater than the above 5%, difficulties in manufacturing are less likely to matter. In addition, in a case of equal to or less than the above 10%, a probability that a contraction flow can be formed with the nozzle hole diameter in a wide range is greater than in a case of 25%. As a result, a liquid jet nozzle with which a contraction flow is reliably formed can be easily manufactured and provided.

A liquid jet nozzle according to a third aspect of the present disclosure is the liquid jet nozzle according to the first aspect or the second aspect, wherein the nozzle hole diameter is in a range from 0.01 mm to 0.15 mm.

According to the present aspect, it was confirmed that the contraction flow could be formed for the liquid nozzle hole having the nozzle hole diameter in the range from 0.01 mm to 0.15 mm.

A liquid jet device according to a fourth aspect of the present disclosure is a liquid jet device including a liquid jet nozzle for hitting a droplet, generated from a jetted continuous flow, against a target object, the liquid jet device including a pressurized liquid supply unit configured to pressurize liquid and supply the liquid to the liquid jet nozzle, wherein the liquid jet nozzle is the liquid jet nozzle according to any one of the first to third aspects.

According to the present aspect, as a liquid jet device, an effect similar to that in any of the first aspect to the third aspect can be obtained.

### Exemplary Embodiment 1

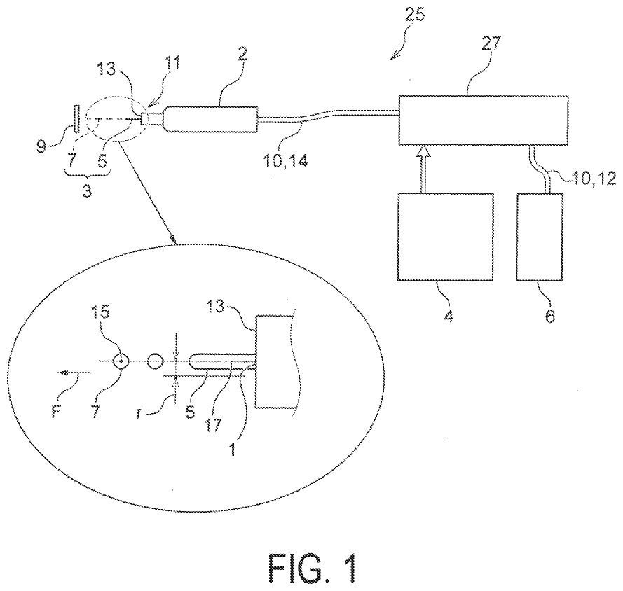

Hereinafter, a liquid jet device provided with a liquid jet nozzle of Exemplary Embodiment 1 according to the present disclosure will be described in detail based on FIG. 1 to FIG. 5. This liquid jet device is a liquid jet device for cleaning skin that is demanded to cause a droplet to fly with good straightness from an end surface on a discharge side of a nozzle hole. Note that, off course, the liquid jet device is not limited to the device described above, and can also be applied to a dental treatment device or the like.

As illustrated in FIG. 1, a liquid jet device 25 according to the present exemplary embodiment includes a jet unit 2 having a liquid jet nozzle 11 for jetting liquid 3, a liquid tank 6 configured to store the liquid 3 to be jetted, a pump unit 27 being a pressurized liquid supply unit, a liquid suction tube 12 configured to form a flow path 10 of the liquid 3 coupling the liquid tank 6 and the pump unit 27, and a pump tube 14 configured to form the same flow path 10 coupling the pump unit 27 and the jet unit 2.

Pump operation of the pump unit 27, such as a pressure of the liquid 3 pumped to the jet unit 2 through the pump tube 14 is controlled by a control unit 4.

Liquid Jet Nozzle

The liquid jet nozzle 11 has one or a plurality of nozzle holes 1, and the liquid 3 highly pressurized is jetted from the nozzle hole 1. In a partially enlarged view in FIG. 1, a reference sign F denotes a liquid jet direction.

The highly-pressurized liquid 3 jetted from the nozzle hole 1 is a continuous flow 5 immediately after jetting, but is immediately dropletized by surface tension of the liquid 3 to split up into a group of droplets 7. The group of droplets 7 fly in a straight line in the liquid jet direction F. A predetermined treatment is performed by hitting the flying group of droplets 7 against a target object 9 one after another.

Note that, in the partially enlarged view in FIG. 1, in order to facilitate understanding of the illustration, dimensions of the droplets 7 and the continuous flow 5 are greatly enlarged with respect to other members, and actual relative dimensional relationships are ignored.

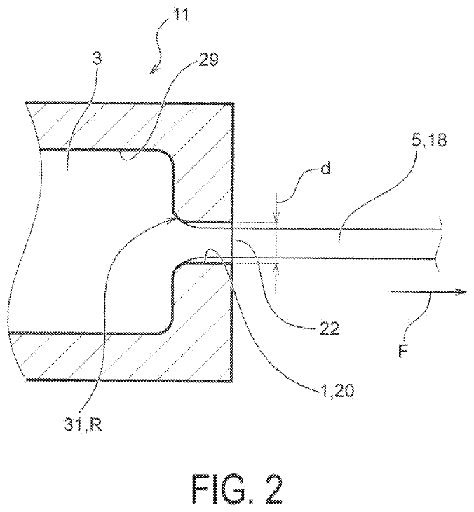

As illustrated in FIG. 2, the liquid jet nozzle 11 has the nozzle hole 1, and a liquid flow path 29 having a diameter greater than that of the nozzle hole 1 and coupled to the nozzle hole 1, and hits the liquid droplet 7, generated from the continuous flow 5 jetted from the nozzle hole 1, against the target object 9. The nozzle hole 1 has a cylindrical shape. Furthermore, the radius of curvature R of an edge 31, which is an edge of an inlet coupled to the liquid flow path 29 of the nozzle hole 1, is formed to be equal to or less than 25% of a nozzle hole diameter d of the nozzle hole 1.

In other words, the radius of curvature R of the edge 31 is set to be related to the nozzle hole diameter d of the nozzle hole 1, and is set in a range in which R/d is equal to or less than 25%.

In FIG. 2, a reference sign 20 denotes a hole wall surface of the nozzle hole 1, and a reference sign 22 denotes a jet port. The hole wall surface 20 has a cylindrical shape with a diameter of d, and the jet port 22 has a circular shape with a diameter of d.

Contraction Flow

FIG. 2 illustrates a state in which the liquid 3 becomes a contraction flow 18 and is jetted from the nozzle hole 1. As illustrated in FIG. 2, the contraction flow 18 refers to a state in which a gap is present between the continuous flow 5 jetted from the nozzle hole 1 and the hole wall surface 20, that is, a state in which the continuous flow 5 is jetted not in contact with the hole wall surface 20. In other words, the contraction flow 18 is a state of being the continuous flow 5 having a diameter less than the nozzle hole diameter d, and jetted. As a result, it has been understood that a jetting velocity V in a contraction flow state is greater than that of a continuous flow jetted in a non-contraction flow state.

In the present exemplary embodiment, the liquid flow path 29 is also formed in a cylindrical shape. Note that, the liquid flow path 29 is not limited to have a cylindrical shape, but may have a polygonal cylindrical shape.

Further, in the present exemplary embodiment, a configuration is adopted in which a fly trajectory of a center 15 of the droplet 7 falls within a range in which a radius r from a central axis 17 of the nozzle hole 1 is equal to or less than 0.5 mm, in an interval from an end surface 13 on a discharge side of the nozzle hole 1 to a predetermined distance.

Nozzle Hole Diameter and Droplet Size

In the present exemplary embodiment, the nozzle hole diameter d of the nozzle hole 1 is made to fall within a range from 0.01 mm to 0.15 mm.

It has been known that a size of the droplet 7 is approximately 1.88 times the nozzle hole diameter d based on a non-viscous linear theory. Since the nozzle hole diameter d of the nozzle hole 1 is from 0.01 mm to 0.15 mm, when calculating the above, the droplet size is from 0.0188 mm to 0.282 mm. Furthermore, in consideration of some variation in the droplet size due to smoothness and the like of the nozzle hole 1, the droplet size is from approximately 0.02 mm to 0.29 mm, as an average droplet size.

Here, since most of a plurality of the droplets 7 are each actually deformed to an oval or the like rather than fully spherical, the “average droplet size” will be determined as an average value based on a longest diameter part and a shortest diameter part.

Jet Pressure

In addition, in the liquid jet device 25 according to the present exemplary embodiment, the pump unit 27, which is a pressurized liquid supply unit, is configured to supply the liquid 3 at a supply pressure such that a jet pressure of the liquid 3 jetted from the nozzle hole 1 is from 0.2 MPa to 10 MPa.

The control unit 4 sets the jet pressure so that the jetting velocity V of the liquid 3 jetted from the nozzle hole 1 is at a predetermined velocity. Determining the jetting velocity V also determines a velocity of the droplet 7 that is flying. The droplet 7 has the same velocity as the jetting velocity V until influence of air resistance is exhibited, and flies at the velocity V.

Explanation that Radius of Curvature R of Edge is Equal to or Less than 25% of Nozzle Hole Diameter d

### (1) Based on “Analysis Value/Theoretical Value” of the Jetting Velocity V

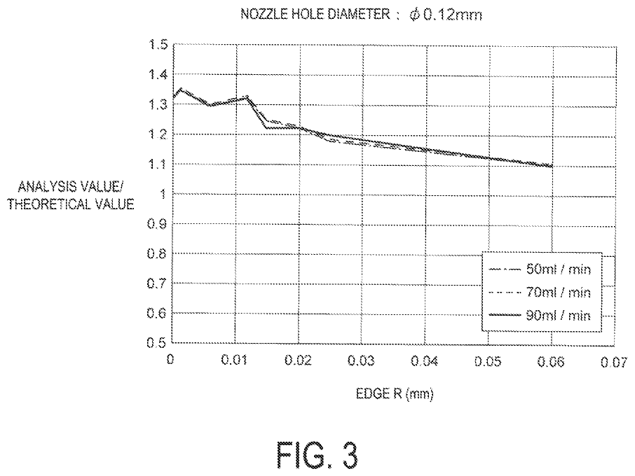

FIG. 3 is a graph showing a relationship between analysis value/theoretical value of the jetting velocity V and the radius of curvature R of the edge 31 of the nozzle hole 1 when the nozzle hole diameter d is 0.12 mm.

Here, an “analysis value” of the jetting velocity V (m/s) is a value obtained for each of set flow rates (ml/min) 50, 70, and 90 of the liquid 3 using a general-purpose three-dimensional thermal fluid analysis software (FLOW-3D). In addition, a “theoretical value” is a theoretical velocity (m/s) determined by dividing each of the set flow rates (ml/min) 50, 70, and 90 of the liquid 3 by a nozzle cross-sectional area of each nozzle hole 1, in each nozzle hole diameter d.

A left part of Table 1 shows that, for the nozzle hole 1 with the nozzle hole diameter of 0.12 mm, when the set flow rates (ml/min) of the liquid 3 are 50, 70, and 90, corresponding theoretical velocities (m/s), that is, the “theoretical values” are 74, 103, and 133, respectively.

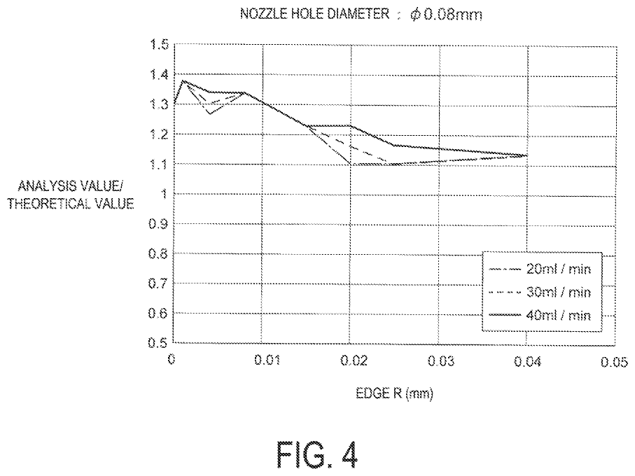

FIG. 4 is a graph showing a relationship between analysis value/theoretical value of the jetting velocity V and the radius of curvature R of the edge 31 of the nozzle hole 1 when the nozzle hole diameter is 0.08 mm.

An “analysis value” is a value obtained for each of set flow rates (ml/min) 20, 30, and 40 of the liquid 3 using the three-dimensional thermal fluid analysis software.

A central part of Table 1 shows that, for the nozzle hole 1 with the nozzle hole diameter of 0.08 mm, when the set flow rates (ml/min) of the liquid 3 are 20, 30, and 40, corresponding theoretical velocities (m/s), that is, the “theoretical values” are 66, 99, and 133, respectively.

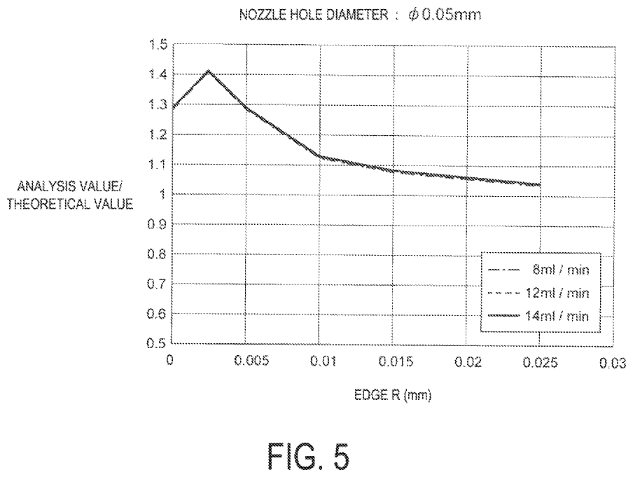

FIG. 5 is a graph showing a relationship between analysis value/theoretical value of the jetting velocity V and the radius of curvature R of the edge 31 of the nozzle hole 1 when the nozzle hole diameter is 0.05 mm.

An “analysis value” is a value obtained for each of set flow rates (ml/min) 8, 12, and 14 of the liquid 3 using the three-dimensional thermal fluid analysis software.

A right part of Table 1 shows that, for the nozzle hole 1 with a nozzle hole diameter of 0.05 mm, when the set flow rates (ml/min) of the liquid 3 are 8, 12, and 14, corresponding theoretical velocities (m/s), that is, the “theoretical values” are 68, 102, and 119, respectively.

TABLE 1

| Nozzle hole | | Nozzle hole | | Nozzle hole | |
|---|---|---|---|---|---|
| diameter (mm) | | diameter (mm) | | diameter (mm) | |
| 0.12 | | 0.08 | | 0.05 | |
| | Theoret- | | Theoret- | | Theoret- |
| Flow | ical | Flow | ical | Flow | ical |
| rate | velocity | rate | velocity | rate | velocity |
| (ml/min) | (m/s) | (ml/min) | (m/s) | (ml/min) | (m/s) |
| 50 | 74 | 20 | 66 | 8 | 68 |
| 70 | 103 | 30 | 99 | 12 | 102 |
| 90 | 133 | 40 | 133 | 14 | 119 |

In FIG. 3, when “analysis value/theoretical value”, which is a ratio of the “analysis value” to the “theoretical value” of the jetting velocity V, at least exceeds 1.1, the jetting velocity V is 1.1 times the theoretical velocity, that is, faster by 10%. This state allows to consider that a contraction flow is formed. In FIG. 3, with the nozzle hole diameter d of 0.12 mm, 1.1 is exceeded for the radius of curvature R of the edge 31 of 0.06 mm. R/d in this case is 0.06/0.12×100=50%. With the nozzle hole diameter d of 0.12 mm, a contraction flow is formed without decreasing the radius of curvature R to 25%. With the nozzle hole diameter d of 0.12 mm, it can be said that a permissible range of the radius of curvature R for forming a contraction flow is wider, accordingly.

In FIG. 4, with the nozzle hole diameter d of 0.08 mm, 1.1 is exceeded for the radius of curvature R of the edge 31 of 0.04 mm. R/d in this case is 0.04/0.08×100=50%. Even with the nozzle hole diameter d of 0.08 mm, a contraction flow is formed without decreasing the radius of curvature R to 25%. Even with the nozzle hole diameter d of 0.08 mm, it can be said that a permissible range of the radius of curvature R for forming a contraction flow is wide.

In FIG. 5, with the nozzle hole diameter d of 0.05 mm, 1.1 is exceeded for the radius of curvature R of the edge 31 of 0.0125 mm. R/d in this case is 0.0125/0.05×100=25%. With the nozzle diameter of 0.05 mm, R/d is 25%, and thus a contraction flow is formed.

From the above, it is understood that a contraction flow is formed when the nozzle hole 1 with the nozzle hole diameter d of 0.12 mm, 0.08 mm, or 0.05 mm is created such that R/d is equal to or less than 25%. Furthermore, it is understood that a contraction flow is formed for the case of the nozzle hole diameter d of 0.12 mm or 0.08 mm, even when R/d is 50%.

In addition, similar data was acquired to perform a similar study for the cases of the nozzle hole diameters d of the nozzle hole 1 of 0.15 mm and 0.01 mm. As a result, it was confirmed that the contraction flow was formed in both the cases as far as the nozzle hole was created such that R/d was equal to or less than 25%.

In Table 2, a theoretical velocity ratio, which is a ratio of an “actual measured value” and the “theoretical value” of the jetting velocity V, is determined for each flow rate (ml/min) in Table 2, for the nozzle hole diameter d of 0.12 mm, 0.08 mm, or 0.05 mm. R/d for the nozzle hole diameter d of 0.12 mm is 1.7%, R/d for 0.08 mm is 1.3%, and R/d for 0.05 mm is 2.0%.

The actual measured value of the jetting velocity V was obtained as follows.

### Actual Measured Value of Jetting Velocity V

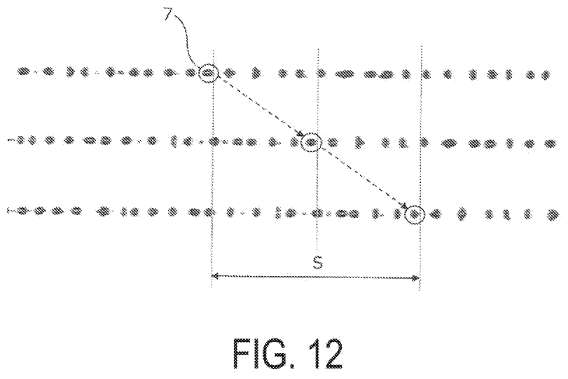

FIG. 12 is a high-speed photographic image obtained by photographing fly trajectories of the droplet 7 jetted from the nozzle hole 1 and flying at the velocity V using a high-speed camera, two to three images (three in the figure) thereof were selected, a travel distance S of the droplet 7 focused was calculated, this was divided by a photographing time interval to determine a velocity of the droplet, and the velocity was used as the actual measured value of the jetting velocity V.

Specifically, an approximate value of R was determined from FIG. 3 to FIG. 5, and a value of R/d determined from the value of R was taken as the actual measured value.

With the nozzle hole diameter d of 0.12 mm, the theoretical velocity ratios are 1.40, 1.35, and 1.28, so an average value is approximately 1.34. Since the value of R at this time is approximately 0.002 mm from FIG. 3, R/d=0.002/0.12=0.0166 . . . ≈1.7%.

With the nozzle hole diameter d of 0.08 mm, the theoretical velocity ratios are 1.44, 1.42, and 1.35, so an average value is approximately 1.41. Since 1.41 is not reached in any of the cases in FIG. 4, a value of R at which the analysis value/theoretical value is maximum is adopted, and the value of R is approximately 0.001 mm, so that R/d=0.001/0.08=0.0125 . . . ≈1.3%.

With the nozzle hole diameter d of 0.05 mm, the theoretical velocity ratios are 1.36, 1.35, and 1.31, so an average value is approximately 1.34. Since the value of R at this time was approximately 0.001 mm or approximately 0.004 mm from FIG. 5, 0.001 mm was adopted in consideration of consistency with the above. Thus, R/d=0.001/0.05=0.02≈2.0%.

TABLE 2

| Nozzle | | Nozzle | | Nozzle | |
|---|---|---|---|---|---|
| diameter (mm) | | diameter (mm) | | diameter (mm) | |
| 0.12 | | 0.08 | | 0.05 | |
| | Theoret- | | Theoret- | | Theoret- |
| Flow | ical | Flow | ical | Flow | ical |
| rate | velocity | rate | velocity | rate | velocity |
| (ml/min) | ratio | (ml/min) | ratio | (ml/min) | ratio |
| 50 | 1.40 | 20 | 1.44 | 8 | 1.36 |
| 70 | 1.35 | 30 | 1.42 | 12 | 1.35 |
| 90 | 1.28 | 40 | 1.35 | 14 | 1.31 |

In Table 2, a minimum value of the theoretical velocity ratios that are each a ratio of an actual measured value and a theoretical value of the jetting velocity V, varies depending on the nozzle hole diameter d, but is 1.28 with d of 0.12 mm, 1.35 with d of 0.08 mm, and 1.31 with d of 0.05 mm.

Thus, it can be understood that the jetting velocities V actually measured are greater than theoretical velocities in the respective nozzle holes 1 measured. In other words, a contraction flow is formed.

In addition, similarly, data of actual measured values and theoretical values was acquired to perform a similar study for the cases of the nozzle hole diameters d of the nozzle hole 1 of 0.15 mm and 0.01 mm. As a result, it was confirmed that the contraction flow was formed in both the cases as far as the nozzle hole was created such that R/d was equal to or less than 25%.

### Description of Effects of Exemplary Embodiment 1

According to the present exemplary embodiment, the radius of curvature R of the edge 31 of the inlet coupled to the liquid flow path 29 of the nozzle hole 1 is equal to or less than 25% of the nozzle hole diameter d of the nozzle hole 1, that is, R/d is equal to or less than 25%. As a result, the droplets 7 made by splitting up the continuous flow 5 of the liquid 3 jetted from the jet port 22 of the nozzle hole 1 can be caused to fly with good straightness, and the liquid 3 can be jetted as the contraction flow 18.

By making the contraction flow 18, the jetting velocity V is increased compared to a case where the contraction flow 18 is not made, and therefore an impact pressure of the droplet 7 can be increased by the increased jetting velocity V.

In addition, as ease of forming the contraction flow 18, it is said that it is good to set the radius of curvature R of the edge 31 of the nozzle hole 1 to zero, that is, truly 90 degrees. However, it is difficult to create the nozzle hole 1 having the radius of curvature R of zero at the edge 31, and an attempt will be made to aim to create one such that a radius of curvature that is close to zero as much as possible.

The inventors have confirmed that there was a range in which the contraction flow 18 could be formed even when the radius of curvature R of the edge 31 was not zero. That is, the inventors have confirmed that even when the radius of curvature R of the edge 31 was not zero, the contraction flow 18 could be formed to a certain range. Furthermore, the inventors have discovered, at the time of confirmation, that as the nozzle hole diameter d was increased, the range in which the contraction flow 18 could be formed widened. In the present exemplary embodiment, “the radius of curvature R of the edge 31 is equal to or less than 25% of the nozzle hole diameter d of the nozzle hole 1” is based on the discovery.

As a result, according to the present exemplary embodiment, when the nozzle hole 1 capable of forming the contraction flow 18 is manufactured, it is not necessary to be vaguely conscious of aiming to make the radius of curvature R of the edge 31 zero, that is, magnitude of the radius of curvature R that is actually required can be grasped depending on the nozzle hole diameter d of the nozzle hole 1, which makes the manufacturing easier.

### Exemplary Embodiment 2

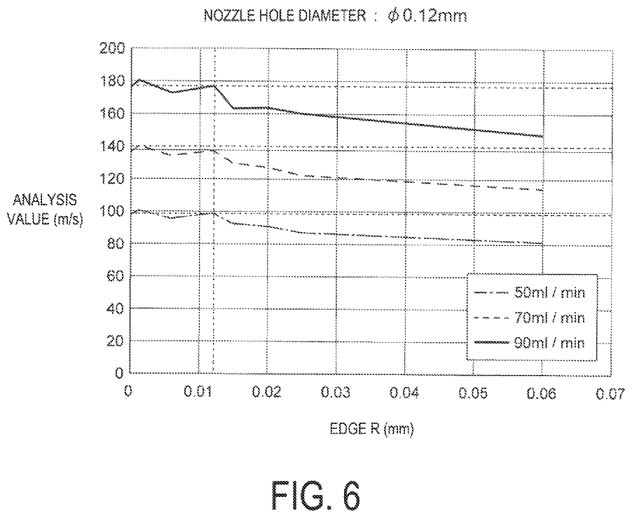

Next, the liquid jet nozzle 1 according to Exemplary Embodiment 2 of the present disclosure will be described based on FIG. 6 to FIG. 11. In FIG. 6 to FIG. 8, a plurality of dashed lines indicate reference values in flow rates, respectively.

In the present exemplary embodiment, a configuration is adopted in which a ratio R/d of the radius of curvature R of the edge 31 to the nozzle hole diameter d is in a range from 5% to 10%.

Explanation that Radius of Curvature R of Edge is in Range from 5% to 10% of Nozzle Hole Diameter d

### (1) Based on “Analysis Value/Reference Value” of the Jetting Velocity V

FIG. 6 is a graph for comparing analysis value and a reference value of the jetting velocity V with respect to the radius of curvature R of the edge 31 of the nozzle hole 1, when the nozzle hole diameter d is 0.12 mm. Set flow rates (ml/min) of the liquid 3 were 50, 70, and 90.

Here, the “analysis value” of the jetting velocity V (m/s) is the same as described above. As for the “reference value”, an analysis value of a jetting velocity was determined when the radius of curvature R of the edge 31 was equal to 0, that is, when the edge 31 was at a right angle, and used as the reference value. The state in which the edge 31 was at a right angle could be said to be an advantageous state in the formation of the contraction flow 18 and, the analysis value was used as the reference value. The “reference value”, which was an analysis value of a jetting velocity when the radius of curvature R, was a right angle, was determined as follows.

### How to Determine Reference Value

Using an analysis model created by setting the edge 31 at a right angle illustrated in FIG. 2, a jetting velocity at each set flow rate (ml/min) was determined by the three-dimensional thermal fluid analysis software.

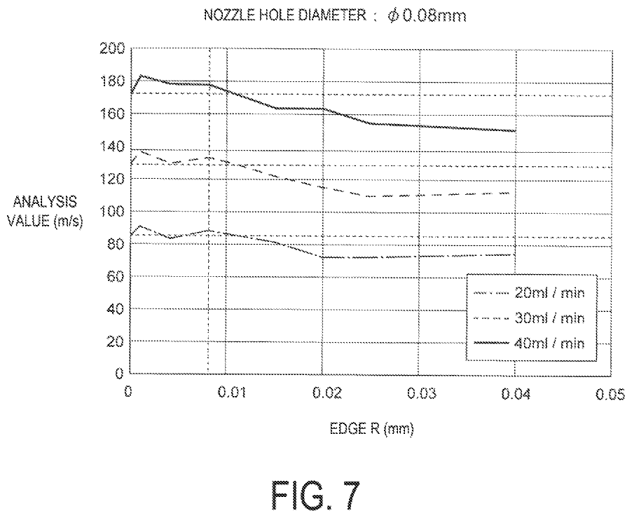

FIG. 7 is a graph showing a relationship between analysis value/reference value of the jetting velocity V and the radius of curvature R of the edge 31 of the nozzle hole 1 when the nozzle hole diameter d is 0.08 mm. Set flow rates (ml/min) of the liquid 3 were 20, 30, and 40.

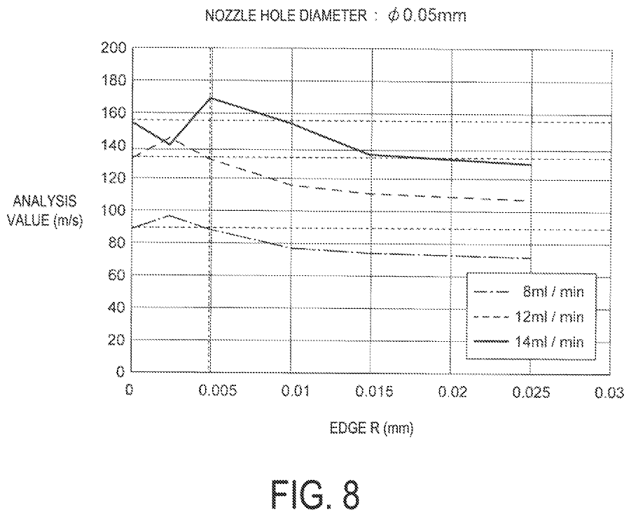

FIG. 8 is a graph showing a relationship between analysis value/reference value of the jetting velocity V and the radius of curvature R of the edge 31 of the nozzle hole 1 when the nozzle hole diameter d is 0.05 mm. Set flow rates (ml/min) of the liquid 3 were 8, 12, and 14.

In FIG. 6, with the nozzle hole diameter d of 0.12 mm, the reference value is exceeded for the radius of curvature R of the edge 31 of 0.012 mm. R/d in this case is 0.012/0.12×100=10%.

In FIG. 7, with the nozzle hole diameter d of 0.08 mm, the reference value is exceeded for the radius of curvature R of the edge 31 of 0.008 mm. R/d in this case is 0.008/0.08×100=10%.

In FIG. 8, with the nozzle hole diameter d of 0.05 mm, the reference value is exceeded for the radius of curvature R of the edge 31 of 0.005 mm. R/d in this case is 0.005/0.05×100=10%.

From the above, it is understood that a probability that the contraction flow 18 is formed is increased, by creating the nozzle hole 1 with the nozzle hole diameter d of 0.12 mm, 0.08 mm, or 0.05 mm such that R/d is equal to or less than 10%.

(2) Based on “Analysis Value/Actual Measured Value” of the Jetting Velocity V

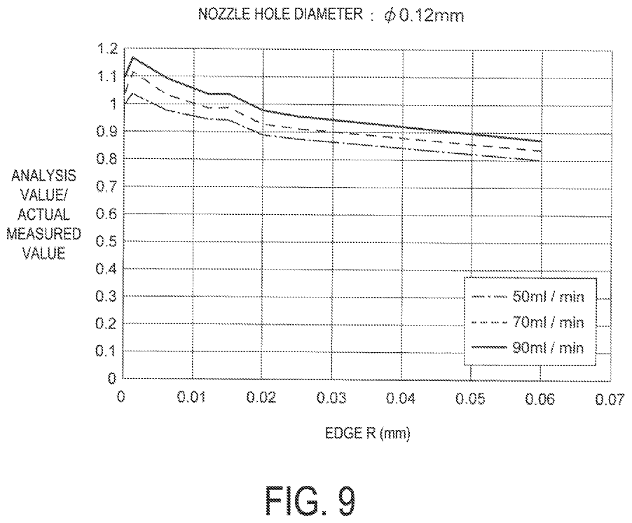

FIG. 9 is a graph showing a relationship between analysis value/actual measured value of the jetting velocity V and the radius of curvature R of the edge 31 of the nozzle hole 1 when the nozzle hole diameter d is 0.12 mm. Set flow rates (ml/min) of the liquid 3 were 50, 70, and 90.

Here, the “analysis value” and the “actual measured value” of the jetting velocity V (m/s) are the same as described above.

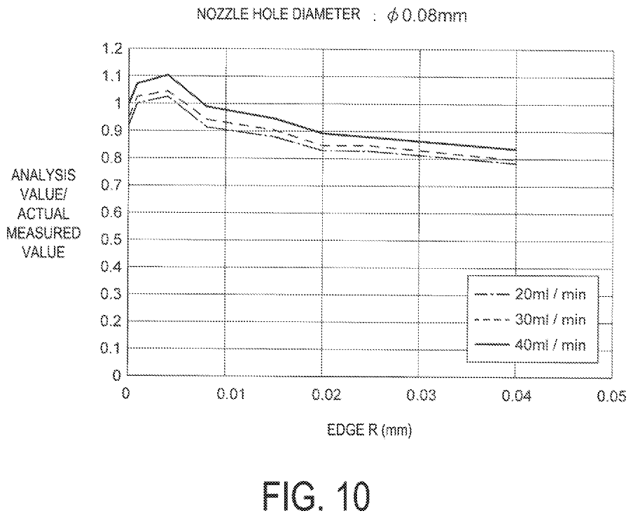

FIG. 10 is a graph showing a relationship between analysis value/actual measured value of the jetting velocity V and the radius of curvature R of the edge 31 of the nozzle hole 1 when the nozzle hole diameter d is 0.08 mm. Set flow rates (ml/min) of the liquid 3 were 20, 30, and 40.

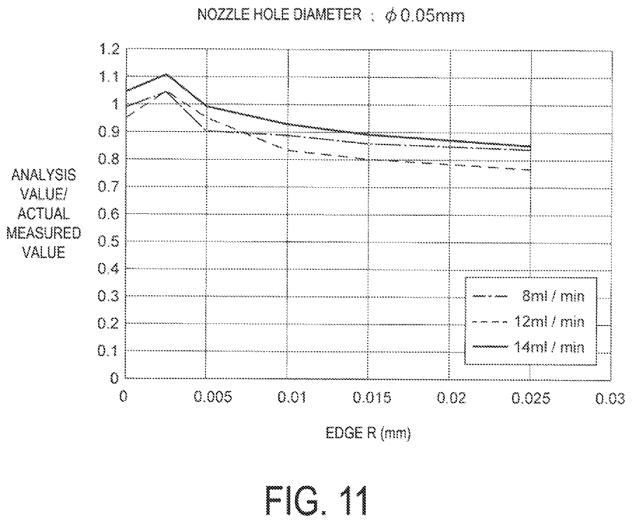

FIG. 11 is a graph showing a relationship between analysis value/actual measured value of the jetting velocity V and the radius of curvature R of the edge 31 of the nozzle hole 1 when the nozzle hole diameter d is 0.05 mm. Set flow rates (ml/min) of the liquid 3 were 8, 12, and 14.

In FIG. 9, with the nozzle hole diameter d of 0.12 mm, 1 is nearly exceeded for the radius of curvature R of the edge 31 of 0.006 mm, at all flow rates (ml/min) of the liquid 3. R/d in this case is 0.006/0.12×100=5%.

In FIG. 10, with the nozzle hole diameter d of 0.08 mm, 1 is nearly exceeded for the radius of curvature R of the edge 31 of 0.004 mm, at all flow rates (ml/min) of the liquid 3. R/d in this case is 0.004/0.08×100=5%.

In FIG. 11, with the nozzle hole diameter d of 0.05 mm, 1 is nearly exceeded for the radius of curvature R of the edge 31 of 0.0025 mm, at all flow rates (ml/min) of the liquid 3. R/d in this case is 0.0025/0.05×100=5%.

From the above, it is understood that a probability that the contraction flow 18 is formed is increased, by creating the nozzle hole 1 with the nozzle hole diameter d of 0.12 mm, 0.08 mm, or 0.05 mm such that R/d is 5%.

That is, it can be said that by setting the radius of curvature R of the edge 31 of the nozzle hole 1 to 5% of the nozzle hole diameter d, the contraction flow 18 can be reliably formed. In addition, the jetting velocity V is amplified up to approximately 1.3 times a theoretical velocity, and an impact pressure 1.3 times stronger than in theory can be generated, and high crushing and cleaning effects can be expected.

In other words, it is possible to generate a desired impact pressure determined by the jetting velocity V, at a flow rate (ml/min) of the liquid 3 that is less than in theory by about 30%, and the flow rate of the liquid 3 to be jetted can be reduced.

According to the present exemplary embodiment, the radius of curvature R of the edge 31 is in the range from 5% to 10% of the nozzle hole diameter d. When R/d is equal to or greater than 5%, manufacturing difficulties are less likely to matter. In addition, when R/d is equal to or less than 10%, a probability that the contraction flow 18 can be formed with the nozzle hole diameter d in a wide range is greater than in a case of 25%. As a result, the liquid jet nozzle 11 with which the contraction flow 18 is reliably formed can be easily manufactured and provided.

### Other Exemplary Embodiments

The liquid jet nozzle 1 and the liquid jet device 25 according to the exemplary embodiments of the present disclosure are based on the configuration described above. However, as a matter of course, modifications, omission, and the like may be made to a partial configuration without departing from the gist of the disclosure of the present application.

What is claimed is:

1. A liquid jet nozzle comprising:
a nozzle hole; and
a liquid flow path having a diameter greater than that of the nozzle hole and coupled to the nozzle hole,
the liquid jet nozzle being configured to hit a droplet, generated from a continuous flow jetted from the nozzle hole, against a target object, wherein
the nozzle hole has a cylindrical shape, and
a curvature radius of an inlet edge of the nozzle hole is equal to or less than 25% of a nozzle hole diameter of the nozzle hole, the inlet being coupled to the liquid flow path.

2. The liquid jet nozzle according to claim 1, wherein
the curvature radius of the edge is in a range from 5% to 10% of the nozzle hole diameter.

3. The liquid jet nozzle according to claim 1, wherein
the nozzle hole diameter is in a range from 0.01 mm to 0.15 mm.

4. The liquid jet nozzle according to claim 2, wherein
the nozzle hole diameter is in a range from 0.01 mm to 0.15 mm.

5. A liquid jet device including the liquid jet nozzle according to claim 1 for hitting a droplet, generated from a jetted continuous flow, against a target object, the liquid jet device comprising:
a pressurized liquid supply unit configured to pressurize liquid and supply the liquid to the liquid jet nozzle.

6. A liquid jet device including the liquid jet nozzle according to claim 2 for hitting a droplet, generated from a jetted continuous flow, against a target object, the liquid jet device comprising:
a pressurized liquid supply unit configured to pressurize liquid and supply the liquid to the liquid jet nozzle.

7. A liquid jet device including the liquid jet nozzle according to claim 3 for hitting a droplet, generated from a jetted continuous flow, against a target object, the liquid jet device comprising:
a pressurized liquid supply unit configured to pressurize liquid and supply the liquid to the liquid jet nozzle.

8. A liquid jet device including the liquid jet nozzle according to claim 4 for hitting a droplet, generated from a jetted continuous flow, against a target object, the liquid jet device comprising:
a pressurized liquid supply unit configured to pressurize liquid and supply the liquid to the liquid jet nozzle, wherein
the liquid jet nozzle is the liquid jet nozzle.
